(19) United States
(12) Patent Application Publication
(10) Pub. No.: US 2022/0373422 A1
(43) Pub. Date: Nov. 24, 2022

(54) VIBRATION DETECTION AND CORRECTION SYSTEM

(71) Applicant: Machine Saver, Inc., Houston, TX (US)

(72) Inventor: Quentin James BACH, Houston, TX (US)

(21) Appl. No.: 17/325,500

(22) Filed: May 20, 2021

(51) Int. Cl. G01M 1/22

(52) U.S. Cl. CPC G01M 1/22

(57) ABSTRACT

A vibration detection and correction device includes a housing and a sensor. The housing includes one or more inputs, a processor, and a memory connected to the processor. The sensor is connected to at least one input of the one or more inputs. The sensor is configured to measure rotation data of a shaft of a rotary machine. The processor is configured to determine dynamic vibration data of the shaft based on the rotation data, determine a coarse runout amount of the shaft based on the rotation data measured each time the rotary machine is coming to a stop, and correct the dynamic vibration data by removing the coarse runout amount from the dynamic vibration data so as to obtain coarse-adjusted vibration data. The memory is configured to store the coarse-adjusted vibration data.

### BACKGROUND

Repair and replacement of shafts, bearings and rotors continues to be a key concern in diagnostics and maintenance of rotary machines. In order to determine whether a machine component such as a bearing, shaft or rotor needs to be repaired or replaced, vibration data of the shaft can be monitored in which displacement of the shaft is measured using vibration sensors. However, errors or inaccuracies in displacement measurements are inevitably caused by mechanical runout (MRO) and/or electrical runout (ERO). MRO refers to the deviation of the cylindrical surface of the shaft from perfect roundness. For example, such deviation can be due to, mechanical defects in the shaft or an offset of the center of the cylindrical surface of the shaft from the center of the journal bearing of the rotary machine. ERO refers to error or inaccuracy in the displacement of a rotating shaft due to variations in the electrical and magnetic properties of the material of the shaft. Total runout (TRO) includes all forms of runout including MRO and ERO. One technique for measuring runout is to remove the shaft from the rotary machine, place the shaft in V-blocks outside the rotary machine, and measure mechanical and electrical characteristics of the shaft using a micrometer and proximity probes so as to map MRO with the micrometer and map ERO with the proximity probes. However, this technique requires disassembly of the rotary machine, extensive backend software and vector analysis, and cannot be performed dynamically in a field transmitter or a signal conditioner itself. In particular, shaft preparation is burdensome and cost prohibitive for rotary machines in the field to be outfitted with a proximity system retrofit. Therefore, there is a need to provide a device which can dynamically account and compensate for runout with respect to the shaft of a rotary machine.

### SUMMARY

According to aspects of the present disclosure there are provided novel solutions for vibration detection and correction that enhance the fidelity of vibration data. For example, optimizing performance of rotary machines by reducing downtime is important for ensuring minimal interruptions to oil and gas, power plant, chemical plant or factory operations. While runout measurement techniques have become prevalent to assess errors and inaccuracies in vibration data, these techniques are not provided in situ and require significant stoppage in the operation of the rotary machine and/or disassembly of the rotary machine. In other words, these techniques must be performed with the shaft being removed from the rotary machine. To overcome these deficiencies, a vibration detection and correction technique can be implemented that dynamically accounts and compensates for runout with respect to the shaft of the rotary machine. Such vibration detection and correction enhances the fidelity of vibration data while optimizing the performance of the rotary machine.

An aspect of the present disclosure provides a vibration detection and correction device to provide improved vibration detection and correction. The vibration detection and correction device comprises a housing, wherein the housing comprises one or more inputs, a processor, and a memory connected to the processor; and a sensor connected to at least one input of the one or more inputs, wherein the sensor is configured to measure rotation data of a shaft of a rotary machine, wherein the processor is configured to de dynamic vibration data of the shaft based on the rotation data, determine a coarse runout amount of the shaft based on the rotation data measured each time the rotary machine is coming to a stop, and correct the dynamic vibration data by removing the coarse runout amount from the dynamic vibration data so as to obtain coarse-adjusted vibration data, and wherein the memory is configured to store the coarse-adjusted vibration data.

In an aspect of the present disclosure, the coarse runout amount includes at least one of a mechanical runout amount or an electrical runout amount.

In an aspect of the present disclosure, the sensor is configured to measure the rotation data in increments across 360° rotations of the shaft and the processor is further configured to overlay the rotation data from each of the 360° rotations of the shaft over one another to obtain a fine runout amount of the shaft; and correct the dynamic vibration data by removing the fine runout amount from the dynamic vibration data so as to obtain fine-adjusted vibration data.

In an aspect of the present disclosure, the processor is further configured to output at least one of the coarse-adjusted vibration data or the fine-adjusted vibration data to a display device for obtaining overall-adjusted vibration data.

In an aspect of the present disclosure, the rotation data includes at least one of a displacement vibration of the rotary machine, a machine speed of the rotary machine or a phase reference position of the rotary machine.

In an aspect of the present disclosure, the rotation data includes a displacement vibration of the rotary machine; and the processor is further configured to differentiate the displacement vibration to obtain a velocity of the shaft.

In an aspect of the present disclosure, the processor is configured to determine the dynamic vibration data using a peak to peak displacement vibration.

An aspect of the present disclosure provides a method implemented on a vibration detection and correction device. The method comprises measuring, by a sensor of the vibration detection and correction device, rotation data of a shaft of a rotary machine; determining, by a processor of the vibration detection and correction device, dynamic vibration data of the shaft based on the rotation data; determining, by the processor, a coarse runout amount of the shaft based on the rotation data measured each time the rotary machine is coming to a stop; correcting, by the processor, the dynamic vibration data by removing the coarse runout amount from the dynamic vibration data so as to obtain coarse-adjusted vibration data; and storing the coarse-adjusted vibration data in a memory of the vibration detection and correction device.

In an aspect of the present disclosure, the coarse runout amount includes at least one of a mechanical runout amount or an electrical runout amount.

In an aspect of the present disclosure, the rotation data is measured in increments across 360° rotations of the shaft; and the method further comprises overlaying the rotation data from each of the 360° rotations of the shaft over one another to obtain a fine runout amount of the shaft; and correcting the dynamic vibration data by removing the fine runout amount from the dynamic vibration data so as to obtain fine-adjusted vibration data.

In an aspect of the present disclosure, the method further comprises outputting at least one of the coarse-adjusted vibration data or the fine-adjusted vibration data to a display device for obtaining overall-adjusted vibration data.

In an aspect of the present disclosure, the rotation data includes at least one of a displacement vibration of the rotary machine, a machine speed of the rotary machine or a phase reference position of the rotary machine.

In an aspect of the present disclosure, the rotation data includes a displacement vibration of the rotary machine; and the method further comprises differentiating the displacement vibration to obtain a velocity of the shaft.

In an aspect of the present disclosure, the determining the dynamic vibration data includes using a peak to peak displacement vibration.

An aspect of the present disclosure provides non-transitory computer readable storage medium having stored thereon a program implemented on a vibration detection and correction device. The program, when executed by a processor of the vibration detection and correction device, cause the vibration detection and correction device to perform one or more operations including the steps of the methods described above.

The above-described novel solution may be implemented at a vibration detection and correction system that includes one or more devices, such as a vibration detection and correction device, according to one or more example embodiments.

Thus, according to various aspects of the present disclosure described herein, it is possible to provide vibration detection and correction based on MRO, ERO, TRO, or any combination thereof. In particular, the novel solution provides improvements to the diagnostics and maintenance of a rotary machine by dynamically accounting and compensating for runout with respect to the shaft of a rotary machine. Therefore, the systems and methods discussed herein provide for using adjusted vibration data to modify a maintenance schedule of a shaft of a rotary machine and/or extend the service life of the shaft of the rotary machine.

### BRIEF DESCRIPTION OF DRAWINGS

In the drawings, like reference numbers generally indicate identical, functionally similar, and/or structurally similar elements.

FIG. 1 is a schematic diagram of a vibration detection and correction system, according to one or more aspects of the present disclosure;

FIG. 2 is a schematic diagram of a sensor arrangement, according to one or more aspects of the present disclosure; and

FIG. 3 is a block diagram of a vibration detection and correction device, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

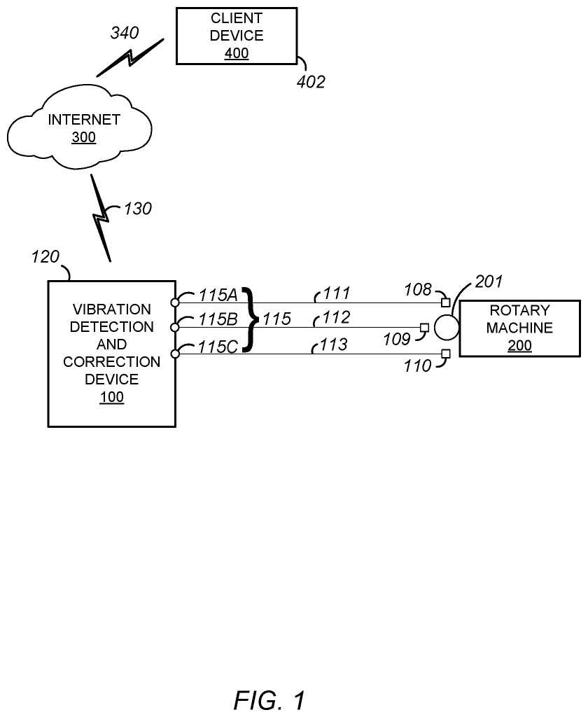

FIG. 1 is a schematic diagram of a vibration detection and correction system, according to one or more aspects of the present disclosure. It should be appreciated that various example embodiments of inventive concepts disclosed herein are not limited to specific numbers or combinations of devices, and there may be one or multiple devices in the vibration detection and correction system, which may itself consist of multiple communication networks and various known or future developed wireless connectivity technologies, protocols, devices, and the like. The vibration detection and correction system can be configured to determine coarse runout and/or fine runout. Coarse runout is the overall peak to peak displacement (total runout) in one or more rotation(s) of the shaft. The shaft peak to peak displacement is the displacement time waveform of displacement amplitude versus time. Fine runout is specific peak to peak shaft displacement with the frequency component, per degree (or overall peak to peak displacement shaft vibration with respect to a specific frequency) or a regular interval subcomponent of the 360 degrees of displacement runout in one or more rotations of the shaft. The vibration detection and correction system can be configured to determine overall vibration and/or dynamic vibration. Overall vibration is the peak to peak displacement movement of the shaft over the time of one or more shaft rotations. Dynamic vibration is the peak to peak shaft displacement of the shaft with respect to specific frequencies and includes measured displacement at a specific shaft rotation position in regular subcomponent intervals of the rotation(s). The vibration detection and correction system can include a vibration detection and correction device 100 coupled via one or more connections 111, 112, 113 to one or more sensors 108, 109, 110, respectively, that can measure rotation data of a shaft 201 of a rotary machine 200. The shaft 201 may, for example, be disposed horizontally along a longitudinal axis of the rotary machine 200. The shaft 201 may be coupled to a rotor (not shown) and may be configured to rotate within a stator or case (not shown). In one or more embodiments, the shaft 201 may be part of a journal bearing such as a fluid film journal bearing. Connection 130 constructively provides access to the Internet 300 for the vibration detection and correction device 100, and connection 340 constructively provides access to the Internet 300 for a client device 400. Client device 400 can include or be coupled to a display device 402. Accordingly, the vibration detection and correction device 100 can transmit vibration data (for example, coarse-adjusted vibration data and/or fine-adjusted vibration data as will be explained below) to the client device 400 for retrieval by an end user or for further analysis. For example, the further analysis can include obtaining overall-adjusted vibration data (as will be explained below).

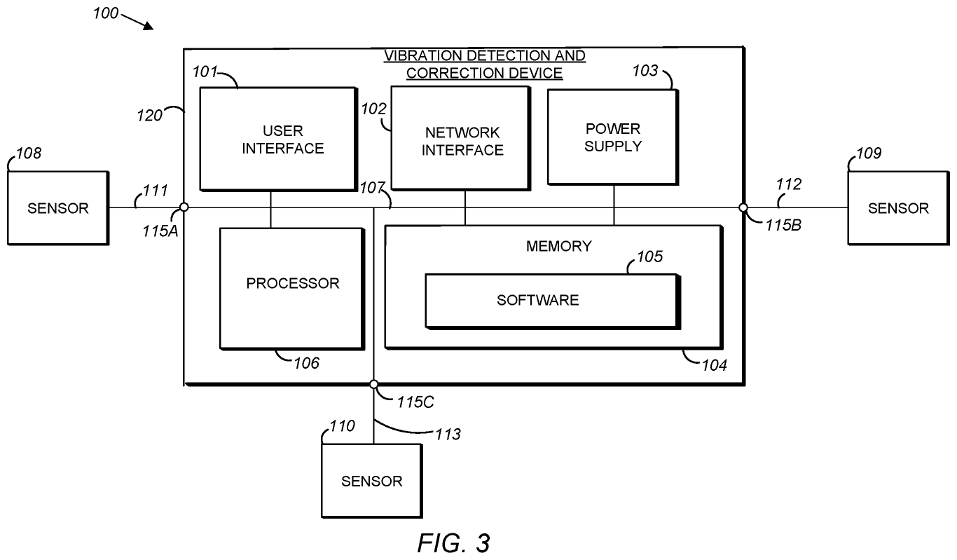

The vibration detection and correction device 100 has a housing 120 which can include one or more elements including, but not limited to, any of a user interface 101, a network interface 102, a power supply 103, a memory 104, a processor 106, any other element, or a combination thereof as discussed and illustrated in reference to FIG. 3.

In one or more embodiments, any of connection 111, connection 112 or connection 113 can be a bidirectional communication link such that any one or more communications or data can be sent and/or received by the corresponding sensor 108, 109, 110, or any combination thereof. Any of connection 111, connection 112 or connection 113 can be a wired (e.g., cable) and/or wireless connection. As shown in FIG. 1, connection 111, connection 112 and connection 113 can be connected to respective one or more inputs 115A, 115B, and 115C (collectively referred to as input(s) 115) of the housing 120 of the vibration detection and correction device 100. In other variations not shown, connection 111, connection 112 and connection 113 can converge so as to be connected to a single input 115 of the housing 120 of the vibration detection and correction device 100. The rotary machine 200 can be, for example, a rotating or reciprocating machine with one or more fluid film journal bearings. In some variations, the rotary machine 200 may be an oil and gas rotating or reciprocating machine and/or have more than 1000 horsepower.

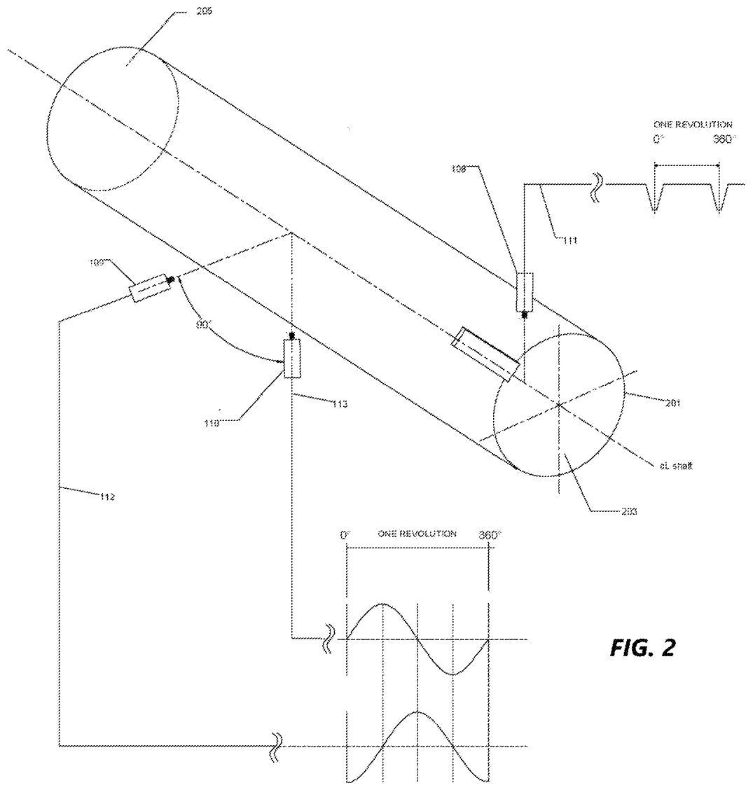

FIG. 2 is a schematic diagram of a sensor arrangement, according to one or more aspects of the present disclosure.

Any of sensors 108, 109, or 110 can be configured to measure at least one of a displacement vibration of the rotary machine 200, a machine speed of the rotary machine 200 or a phase reference position (360° rotational position) of the rotary machine 200. The rotation data may be measured in smaller increments (for example, 1° increments or 5° increments) across 360° of a full rotation. In one or more embodiments, sensor 108 can be a phase reference probe configured to monitor a reference point on the shaft 201. Sensor 108 can be disposed at or about the shaft 201 such that sensor 108 is within a proximity of the shaft 201 but does not physically contact the shaft 201. The proximity of sensor 108 to the shaft 201 can be based on one or more operational characteristics of sensor 108, such as the type of sensor (e.g., inductive, capacitive, magnetic, ultrasonic, etc.), the physical dimensions of the sensor, and/or the electromagnetic properties of the sensor. The vibration detection and correction device 100 can receive one or more reference point measurements from sensor 108. The vibration detection and correction device 100 can determine the specific position of the shaft 201 over a 360° rotation of the shaft 201 based on the one or more reference point measurements received from sensor 108.

Sensor 109 can be an X radial proximity probe and sensor 110 can be a Y radial proximity probe mounted 90° apart from sensor 109. Sensors 109 and 110 can be disposed at or about the shaft 201 such that the sensors 109 and 110 are within a proximity of the shaft 201. The proximity of the sensors 109 and 110 to the shaft 201 can be based on one or more operational characteristics similar to the discussion above with reference to sensor 108. In one or more embodiments, sensors 109 and 110 are disposed in the same plane 90° apart such that the sensors 109 and 110 are configured to be in alignment so as to take measurements with respect to the same cross section of the shaft 201. In other words, sensors 109 and 110 are configured to sense the same TRO 90° apart as the shaft 201 rotates. In one or more embodiments, sensors 109 and 110 are disposed at or about a first or distal end 203 of the shaft 201 while sensor 108 is disposed at or about a second or proximal end 205 of the shaft 201. In one or more embodiments, sensor 108 is disposed 90° apart from sensor 109 such that sensor 108 would be in a position that vertically corresponds to the position of sensor 110 if both were disposed at the same end of the shaft 201. Sensors 109 and 110 may be used for coarse TRO correction (e.g., peak to peak displacement per rotation) correction whereas sensor 108 is not necessarily required to obtain a coarse TRO correction. As an example, coarse TRO correction (i.e., obtaining coarse-adjusted vibration data) can be performed by buffering the data from sensors 109 and 110 before a machine speed of the rotary machine 200 goes to zero (e.g., in a 10 second time period before stoppage when the vibration level is ≤0.05 mil). Sensor 108 may be used for fine TRO correction/obtaining fine-adjusted vibration data (e.g., peak to peak displacement correction per a predetermined degree rotation increment (for example, 1°) of the full 360° rotation). In some variations, sensor 108 may be also be used for coarse TRO correction.

Sensor 109 can measure or receive one or more X location measurements. The one or more X location measurements from sensor 109 are indicative of radial vibration in peak to peak displacement or shaft movement along an X-axis and one or more Y location measurements from sensor 110 are indicative of radial vibration data in peak to peak displacement or shaft movement along a Y-axis. Peak to peak displacement refers to the difference between the maximum positive amplitude of a waveform and the maximum negative amplitude of the waveform. In other words, peak to peak displacement is the total distance traveled by a vibrating shaft from the minimum to the maximum. During vibration, the shaft 201 moves in an elliptical orbit (in a view from the first end 203 of the shaft 201) and therefore at least one of sensor 109 or sensor 110 can detect the specific location(s) where the orbit of the shaft 201 is out-of-round and can indicate high spot(s) in the elliptical orbit of the shaft 201. The one or more X and/or Y location measurements from sensor 109 and sensor 110 (collectively referred to as vibration data), respectively, provide X-Y points so the runout associated with the shaft 201 can be plotted in an orbit graph. For example, vibration detection and correction device 100 can receive one or more X location measurements from sensor 109 and one or more Y location measurements from sensor 110. The vibration detection and correction device 100 can determine dynamic vibration data based on the vibration data (for example, one or more X location measurements from sensor 109, the Y location measurements from sensor 110, or both). MRO is determine as the difference between the elliptical orbit of the shaft 201 and a perfectly round orbit.

In summary, sensors 109 and 110 can be used for coarse TRO correction to obtain a coarse runout amount (coarse TRO) by adding MRO (determined by detecting the specific location(s) where the orbit of the shaft 201 is out-of-round) and ERO (determined by measuring, for example, eddy current properties of the shaft 201). Sensor 108 may be used for fine TRO correction to obtain a fine runout amount (fine TRO) by measuring dynamic vibration data, for example, in 1° increments across 360° rotations and the one or more X location measurements and the one or more Y location measurements corresponding to several rotations can be overlaid for comparative purposes.

The vibration detection and correction device 100 is further configured to determine the velocity of the shaft 201. The velocity of the shaft 201 can be determined by differentiating the displacement data (e.g., peak to peak displacement per rotation) measured by any of sensors 108, 109, 110. In other words, by taking the derivative of the displacement data measured by any of sensors 108, 109, 110, the velocity of the shaft 201 can be determined. By considering the vibration data in terms of velocity of the shaft 201, a greater resolution can be obtained at higher speeds. Shaft velocity as a measurand will also provide a more consistent high or severe alarm level threshold on variable speed machines.

While FIG. 2 illustrates only single sensors 109, 110 and 108, the present disclosure contemplates any number of sensors 109, 110, and/or 108 can be provided in accordance with the number of journal bearings and the complexity of the rotary machine 200. For example, one or more sensors 108 can be provided, one or more sensors 109 can be provided, and/or one or more sensors 110 can be provided.

Raw rotation data (the one or more reference point measurements from sensor 108) may be measured as the amplitude of the vibration over time which constitutes a time waveform. The raw rotation data may be a complex signal including a series of sine waves overlaid over one another and can be filtered into frequency components to obtain or determine dynamic vibration data. For example, a Fast Fourier Transform of the time waveform can be taken to obtain the amplitude of the vibration with specific frequencies. Through such overlay, a fine runout amount can be determined and subtracted from the dynamic vibration data to obtain fine-adjusted vibration data.

In one or more embodiments, the runout can be derived from the rotation data (for example, the one or more reference point measurements, the one or more X location measurements, the one or more Y location measurements, or any combination thereof (collectively referred to as rotation data) measured and/or received by the sensors 108, 109, 110 each time the rotary machine 200 is coming to a stop when the centrifugal energy of the rotary machine 200 is low. For example, “coming to a stop” refers to a phase in which a machine speed of the rotary machine 200 is two hundred (200) revolutions per minute (RPM) or lower. In particular, “coming to a stop” may be a phase in which the machine speed is 5 RPM or lower. During this phase, the vibration level should be effectively zero (i.e., <0.001 mil).

As described above, MRO is determined as the difference between the elliptical orbit of the shaft 201 and a perfectly round orbit. ERO is determined by converting the interaction between the emitted magnetic field of one or more sensors 108, 109 and/or 110 and the induced magnetic field of one or more sensors 108, 109 and/or 110 into distance. It is possible for the MRO and ERO to change over time. Mechanical damage such as a rub between the shaft and the bearing housing or rust on the shaft could change the measured MRO. A stress fracture in the shaft material or changes in the magnet properties of the shaft over time could change the measured shaft ERO over time. Accordingly, the peak to peak displacement data can be taken each time the rotary machine 200 comes to a stop so that the peak to peak displacement data at each stoppage can be sampled. The data collected as the machine comes to a stop includes all the MRO and ERO data. Since there is little centrifugal energy associated with real machine vibration data, the data collected at stoppage is the false TRO data which may then be subtracted from the true machine vibration data when the machine is running and centrifugal energy is present. For example, the vibration detection and correction device 100 can request the rotation data from any of the one or more sensors 108, 109 and/or 110 each time the rotary machine 200 comes to a stop, the one or more sensors 108, 109 and/or 110 can automatically send associated measurements to the vibration detection and correction device 100 each time the rotary machine 200 comes to a stop (e.g., at 5 RPM), or both. Accordingly, coarse TRO can be continuously adjusted and updated. In some variations, an alert may be outputted to the client device 400 to notify a user that TRO has changed more than a certain threshold from the last measurement (e.g., a change of >5% or a change of >10%). This provides a more accurate measurement of ERO and is helpful to isolate noise in the vibration data resulting from, for example, magnetism. MRO and/or ERO can be subtracted from the dynamic vibration data as an adjustment to obtain coarse-adjusted vibration data. In other words, the coarse runout amount removed from the dynamic vibration data includes at least one of a mechanical runout amount or an electrical runout amount and the coarse-adjusted vibration data constitutes dynamic vibration data having at least one of MRO or ERO removed therefrom so as to obtain a more accurate condition of the shaft 201.

The dynamic vibration data can be measured, for example, in 1° increments across 360° rotations and the one or more X location measurements and the one or more Y location measurements corresponding to several rotations can be overlaid for comparative purposes and outputted to the client device 400, for example, for display on display device 402. Based on the overlay, the dynamic vibration data can be analyzed so as to obtain fine TRO. Sensor 108 can measure where the reference point of shaft 201 is at any time during the 360° rotation of the shaft 201. Electrical (e.g., eddy current) properties of the shaft 201 can be measured to determine ERO. For example, if fine TRO is determined to significantly occur between 5-10° and between 180-185°, this fine TRO can be subtracted from the dynamic vibration data to obtain fine-adjusted vibration data. Accordingly, it can then be determined if the shaft 201 is out of balance or out of alignment, for example. The coarse-adjusted vibration data and/or the fine-adjusted vibration data can be outputted to the client device 400 (in particular, display device 402) for obtaining overall-adjusted vibration data. For example, adjusted time waveform vibration data in regular intervals of the 360° of rotation can be obtained. In other words, improved and overall-adjusted vibration data can be obtained via subtracting the TRO in smaller regular increments (for example, 1°) of peak to peak displacement vibration data across the 360° of each full rotation.

In some variations, the processor 106 may be configured to determine a maintenance schedule for the shaft 201 including service intervals at which the shaft 201 is retrieved or removed from the rotary machine 200 for repair or replacement. The processor 106 may be configured to associate at least one of the coarse-adjusted vibration data or the fine-adjusted vibration data with a threshold vibration level (e.g., 5 mil), and set the maintenance schedule for the shaft 201 based on the at least one of the coarse-adjusted vibration data or the fine-adjusted vibration data indicating that the threshold vibration level has been exceeded. For example, if the coarse-adjusted vibration data or fine-adjusted vibration data indicates that the dynamic vibration and/or overall vibration exceeds the threshold level, the processor 106 can modify the maintenance schedule for the shaft 201 so as to recommend immediate servicing and output a notification to the client device 400 (in particular, display device 402). Due to the filtering of the coarse runout and/or the fine runout from the raw vibration data, the vibration detection and correction device 100 facilitates more accurate and cost-effective maintenance of the shaft 201 and extension of the service life of the shaft 201. The shaft 201 can be removed from the rotary machine 200 for servicing based on the maintenance schedule. After repair, the shaft 201 can be reinstalled in the rotary machine 200 for further use. Alternatively, the shaft 201 can be replaced altogether and the new shaft can be installed in the rotary machine 200 for use.

Any of sensors 108, 119, or 110 can be disposed or otherwise mounted at or about a proximity to the shaft 201 so as to be able take measurements from a position, for example, a position of ≤0.1 inches away from the shaft 201. The vibration detection and correction device 100 can be positioned, for example, ≤10 meters from the rotary machine 200. In other words, if connection 111, connection 112 or connection 113 is a wired (e.g., a cable) connection, the length of the cable may be ≤10 meters.

In view of the foregoing, the vibration detection and correction device 100 provides a simple way to determine if MRO and/or ERO has changed since the last time the rotary machine 200 stopped. The vibration detection and correction device 100 can output to the client device 400 any significant change in MRO and/or ERO since the last stoppage by storing and comparing MRO data and ERO data collected each time the rotary machine 200 stops, for example, for display on display device 402. In other words, the vibration detection and correction device 100 provides a MRO/ERO filter for analysis purposes and enables fine MRO/ERO adjustment of the vibration data. For example, in non-API (American Petroleum Institute) Standard 670 applications, the dynamic vibration data can be determined using a peak to peak displacement and then the dynamic vibration data can continuously corrected by removing the runout amount from the dynamic vibration data so as to ultimately determine the coarse-adjusted vibration data and/or the fine-adjusted vibration data. Consequently, it is possible in non-API Standard 670 applications to retrofit a rotary machine to have proximity probes in a retrofit with minimal shaft preparation using the above-described coarse and fine MRO and/or ERO adjustments.

FIG. 3 is a block diagram of a vibration detection and correction device 100, according to one or more aspects of the present disclosure.

The vibration detection and correction device 100 has a housing 120. One or more components or elements can be disposed within the housing 120. For example, one or more elements including, but not limited to, any of a user interface 101, a network interface 102, a power supply 103, a memory 104, a processor 106, any other element, or a combination thereof can be disposed within the housing 120.

The network interface 102 can include, but is not limited to, various network cards, interfaces, and circuitry implemented in software and/or hardware to enable communications with any of one or more elements of a client device 400, any other device, or a combination thereof using the communication protocol(s) in accordance with any connection. The power supply 103 supplies power to any one or more of the internal elements of the vibration detection and correction device 100, for example, through an internal bus 107. The power supply 103 can be a self-contained power source such as a battery pack with an interface to be powered through an electrical charger connected to an outlet (for example, either directly or by way of another device). The power supply 103 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The processor 106 controls the general operations of the vibration detection and correction device 100 and can comprise any of or any combination of a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of computer-readable instructions, algorithms, or software including the software 105 stored in memory 104 for controlling the operation and functions of the vibration detection and correction device 100 in accordance with the embodiments described in the present disclosure. Communication between any of the element (for example, elements 101, 102, 103, 104, and/or 106) of the vibration detection and correction device 100 can be established using the internal bus 107.

The memory 104 can comprise a single memory or one or more memories or memory locations that can include, but are not limited to, any of a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical drive, a hard disk or any other various layers of memory hierarchy. The memory 104 can be used to store any type of computer-readable instructions, software, or algorithms including software 105 for controlling the general function and operations of the vibration detection and correction device 100 in accordance with the embodiments described in the present disclosure. In one or more embodiments, software 105 includes one or more applications and/or computer-readable instructions for providing vibration detection and correction.

The user interface 101 can comprise any of one or more tactile inputs (for example, a push button, a selector, a dial, etc.), a camera, a keyboard, an audio input, for example, a microphone, a keypad, a liquid crystal display (LCD), a thin film transistor (TFT), a light-emitting diode (LED), a high definition (HD) or other similar display device including a display device having touch screen capabilities so as to allow interaction between one or more users and the vibration detection and correction device 100, or a combination thereof.

In one or more embodiments, the vibration detection and correction device 100 is coupled or connected to a client device 400 via the Internet 300 using connection 130 and connection 340 so as to provide and/or receive audio and/or visual inputs and/or outputs to and/or from a user. In one or more embodiments, the client device 400 can comprise an audio capture device, an audio output device, an image capture device, a display device 402, any other element, or any combination thereof.

In one or more embodiments, the vibration detection and correction device 100 can employ a serial Modbus RS485 digital communications protocol output and act as a slave device for a master controller. The vibration detection and correction device 100 can be used with machine learning algorithms to create extremely high resolution spectrum/time waveform and orbit graphs and automatically diagnose impending machine failures and anomalies.

Further, any, all, or some of the electronic elements or electronic computing devices can be adapted to execute any operating system, including Linux, UNIX, Windows, MacOS, DOS, and ChromOS as well as virtual machines adapted to virtualize execution of a particular operating system, including customized and proprietary operating systems. Any, all or some of the electronic components or electronic computing devices are further equipped with components to facilitate communication with other devices over the one or more network connections to local and wide area networks, wireless and wired networks, public and private networks, and any other communication network enabling communication in the vibration detection and correction device 100.

According to some example embodiments of inventive concepts disclosed herein, there are provided novel solutions for vibration detection and correction that enhance the fidelity of vibration data. The vibration detection and correction device provides a significant improvement over traditional systems as the novel vibration detection and correction device not only determines dynamic vibration data and coarse/fine runout amounts but also removes the coarse runout amount and/or the fine runout amount from the dynamic vibration data so as to obtain coarse-adjusted vibration data for derivation of overall-adjusted vibration data. By providing such enhanced vibration data, errors or inaccuracies associated with runout are reduced or eliminated. For example, oil and gas machinery, power plants, chemical plants, factories, propulsion systems, etc. are improved by providing vibration data with higher fidelity.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A vibration detection and correction device comprising:
a housing, wherein the housing comprises:
one or more inputs;
a processor; and
a memory connected to the processor; and
a sensor connected to at least one input of the one or more inputs, the sensor being configured to measure rotation data of a shaft of a rotary machine,
wherein the processor is configured to:
determine dynamic vibration data of the shaft based on the rotation data;
determine a coarse runout amount of the shaft based on the rotation data measured each time the rotary machine is coming to a stop; and
correct the dynamic vibration data by removing the coarse runout amount from the dynamic vibration data so as to obtain coarse-adjusted vibration data, and
wherein the memory is configured to store the coarse-adjusted vibration data.

2. The vibration detection and correction device of claim 1, wherein the coarse runout amount includes at least one of a mechanical runout amount or an electrical runout amount.

3. The vibration detection and correction device of claim 1, wherein:
the sensor is configured to measure the rotation data in increments across 360° rotations of the shaft; and
the processor is further configured to:
overlay the rotation data from each of the 360° rotations of the shaft over one another to obtain a fine runout amount of the shaft; and
correct the dynamic vibration data by removing the fine runout amount from the dynamic vibration data so as to obtain fine-adjusted vibration data.

4. The vibration detection and correction device of claim 3, wherein the processor is further configured to output at least one of the coarse-adjusted vibration data or the fine-adjusted vibration data to a display device for obtaining overall-adjusted vibration data.

5. The vibration detection and correction device of claim 3, wherein the processor is further configured to associate at least one of the coarse-adjusted vibration data or the fine-adjusted vibration data with a threshold vibration level, and set a maintenance schedule for the shaft based the threshold vibration level being exceeded.

6. The vibration detection and correction device of claim 1, wherein the rotation data includes at least one of a displacement vibration of the rotary machine, a machine speed of the rotary machine or a phase reference position of the rotary machine.

7. The vibration detection and correction device of claim 1, wherein:
the rotation data includes a displacement vibration of the rotary machine; and
the processor is further configured to differentiate the displacement vibration to obtain a velocity of the shaft.

8. A method implemented on a vibration detection and correction device, the method comprising:
measuring, by a sensor of the vibration detection and correction device, rotation data of a shaft of a rotary machine;
determining, by a processor of the vibration detection and correction device, dynamic vibration data of the shaft based on the rotation data;
determining, by the processor, a coarse runout amount of the shaft based on the rotation data measured each time the rotary machine is coming to a stop;
correcting, by the processor, the dynamic vibration data by removing the coarse runout amount from the dynamic vibration data so as to obtain coarse-adjusted vibration data; and
storing the coarse-adjusted vibration data in a memory of the vibration detection and correction device.

9. The method of claim 8, wherein the coarse runout amount includes at least one of a mechanical runout amount or an electrical runout amount.

10. The method of claim 8, wherein:
the rotation data is measured in increments across 360° rotations of the shaft; and
the method further comprises:
overlaying the rotation data from each of the 360° rotations of the shaft over one another to obtain a fine runout amount of the shaft; and
correcting the dynamic vibration data by removing the fine runout amount from the dynamic vibration data so as to obtain fine-adjusted vibration data.

11. The method of claim 10, further comprising outputting at least one of the coarse-adjusted vibration data or the fine-adjusted vibration data to a display device for obtaining overall-adjusted vibration data.

12. The method of claim 10, further comprising associating at least one of the coarse-adjusted vibration data or the fine-adjusted vibration data with a threshold vibration level, and setting a maintenance schedule for the shaft based the threshold vibration level being exceeded.

13. The method of claim 8, wherein the rotation data includes at least one of a displacement vibration of the rotary machine, a machine speed of the rotary machine or a phase reference position of the rotary machine.

14. The method of claim 8, wherein:
the rotation data includes a displacement vibration of the rotary machine; and
the method further comprises differentiating the displacement vibration to obtain a velocity of the shaft.

15. A non-transitory computer readable storage medium having stored thereon a program implemented on a vibration detection and correction device, the program causing the vibration detection and correction device to perform steps comprising:
measuring, by a sensor of the vibration detection and correction device, rotation data of a shaft of a rotary machine;
determining, by a processor of the vibration detection and correction device, dynamic vibration data of the shaft based on the rotation data;
determining, by the processor, a coarse runout amount of the shaft based on the rotation data measured each time the rotary machine is coming to a stop;
correcting, by the processor, the dynamic vibration data by removing the coarse runout amount from the dynamic vibration data so as to obtain coarse-adjusted vibration data; and
storing the coarse-adjusted vibration data in a memory of the vibration detection and correction device.

16. The non-transitory computer readable storage medium of claim 15, wherein the coarse runout amount includes at least one of a mechanical runout amount or an electrical runout amount.

17. The non-transitory computer readable storage medium of claim 15, wherein:
the rotation data is measured in increments across 360° rotations of the shaft; and
the program causes the vibration detection and correction device to perform further steps comprising:
overlaying the rotation data from each of the 360° rotations of the shaft over one another to obtain a fine runout amount of the shaft; and
correcting the dynamic vibration data by removing the fine runout amount from the dynamic vibration data so as to obtain fine-adjusted vibration data.

18. The non-transitory computer readable storage medium of claim 17, wherein the program causes the vibration detection and correction device to perform a further step comprising outputting at least one of the coarse-adjusted vibration data or the fine-adjusted vibration data to a display device for obtaining overall-adjusted vibration data.

19. The non-transitory computer readable storage medium of claim 15, wherein the program causes the vibration detection and correction device to perform further steps comprising associating at least one of the coarse-adjusted vibration data or the fine-adjusted vibration data with a threshold vibration level, and setting a maintenance schedule for the shaft based on the at threshold vibration level being exceeded.

20. The non-transitory computer readable storage medium of claim 15, wherein:
the rotation data includes a displacement vibration of the rotary machine; and
the program causes the vibration detection and correction device to perform a further step comprising differentiating the displacement vibration to obtain a velocity of the shaft.
